(19) United States
(12) Patent Application Publication
(10) Pub. No.: US 2026/0138608 A1
(43) Pub. Date: May 21, 2026

(54) APPARATUS AND METHOD FOR CONTROLLING INERTIA DRIVING, AND AN ECO-FRIENDLY VEHICLE USING THE SAME

(71) Applicants: HYUNDAI MOTOR COMPANY, Seoul (KR); KIA CORPORATION, Seoul (KR)

(72) Inventors: Seo Yeon Kim, Hwaseong-si (KR); Jun Haeng Heo, Hwaseong-si (KR); Tae Kyun Kim, Hwaseong-si (KR); Seong Joo Kim, Hwaseong-si (KR); Kyu hwan Jo, Hwaseong-si (KR); Jun Yong Park, Hwaseong-si (KR)

(73) Assignees: HYUNDAI MOTOR COMPANY, Seoul (KR); KIA CORPORATION, Seoul (KR)

(21) Appl. No.: 19/226,901

(22) Filed: Jun. 3, 2025

(30) Foreign Application Priority Data
Nov. 21, 2024 (KR) 10-2024-0167352

(51) Int. Cl. B60W 30/18; B60W 30/045

(52) U.S. Cl. CPC B60W 30/18072; B60W 30/045; B60W 2520/10; B60W 2552/30; B60W 2720/106

(57) ABSTRACT

An apparatus includes: a communication interface configured to receive necessary operation information required for inertia driving control of a vehicle; and a processor configured to identify whether a deceleration event will occur based on road curvature information contained in the necessary operation information, identify target vehicle speed, identify inertia driving control time, control torque for the inertia driving control based on the road curvature information identified to contain the presence of the deceleration event, and control an actuator to perform the inertia driving control for the deceleration event based on identification results.

### CROSS REFERENCE TO RELATED APPLICATION

The present application claims the benefit of and priority under 35 U.S.C. 119 to Korean Patent Application No. 10-2024-0167352, filed Nov. 21, 2024, in the Korean Intellectual Property Office, the entire contents of which are incorporated herein for all purposes by this reference.

### TECHNICAL FIELD

The disclosure relates to technology for controlling inertia driving, and more particularly to an apparatus implemented to perform inertia driving control based on road curvature information, an inertia driving control method thereof, and an eco-friendly vehicle including the same.

### BACKGROUND

An eco-friendly vehicle, such as a fuel cell vehicle, an electric vehicle, a plugin electric vehicle, and a hybrid vehicle, usually includes a motor to generate a driving force.

The eco-friendly vehicle including the motor as a power source expands the range of energy efficiency improvement control, thereby pursuing improved energy efficiency.

Inertia driving control of a vehicle refers to when the vehicle actively performs deceleration control without a driver operating a brake pedal. Inertia driving control may help improve energy efficiency.

Accordingly, there is a need for a method of improving the energy efficiency of a vehicle by allowing or controlling the vehicle to decelerate based on or using the inertia driving control in a deceleration situation.

The foregoing matters described as the related art are provided only to enhance understanding of the background of the disclosure. The presence of the foregoing descriptions in the Background section should not be taken as an acknowledgement that the foregoing descriptions are prior art already known to a person having ordinary skill in the art.

### SUMMARY

An embodiment of the disclosure has been proposed to meet the foregoing needs. An aspect of the disclosure is to provide an apparatus implemented to perform inertia driving control based on curvature information of a road on which an eco-friendly vehicle travels (i.e., based on road curvature information), an inertia driving control method thereof, and an eco-friendly vehicle including the same.

An aspect of the disclosure is to provide an apparatus implemented to perform inertia driving control based on a location of a vehicle and road curvature information obtained by a global positioning system (GPS), an inertia driving control method thereof, and an eco-friendly vehicle including the same.

An aspect of the disclosure is to provide an apparatus implemented to perform inertia driving control based on road curvature information, an inertia driving control method thereof, and an eco-friendly vehicle including the same, in which the inertia driving control is performed even in situations other than road junctions, thereby expanding the range of the inertia driving control and further improving energy efficiency.

It should be noted that aspects of the disclosure are not limited to the above-mentioned aspects. Other aspects not mentioned above should be apparent to those of ordinary skill in the art from the following descriptions.

According to an embodiment of the disclosure, an apparatus for controlling inertia driving may include: a communication interface configured to receive necessary operation information required for inertia driving control of a vehicle; and a processor configured to determine whether a deceleration event will occur based on road curvature information contained in the necessary operation information, determine a target vehicle speed, determine inertia driving control time, control torque for the inertia driving control based on the road curvature information indicative of the deceleration event, and control an actuator to perform the inertia driving control for the deceleration event based on determination results.

According to an embodiment of the disclosure, the road curvature information may include a radius of curvature including a sign of the curvature, a length of a curvature section, and a first distance corresponding to a distance between a curvature section starting point and the vehicle. The processor may determine that the deceleration event will occur based on the road curvature information, wherein the determination is made based on the radius of the curvature being smaller than a first reference value, the length of the curvature section being greater than a second reference value, and the first distance being smaller than a third reference value.

According to an embodiment of the disclosure, the road curvature information may include a radius of curvature including a sign of the curvature, a length of a curvature section, and a first distance corresponding to a distance between a curvature section starting point and the vehicle. The processor may determine that the deceleration event will occur based on the road curvature information, wherein the determination is made based on the radius of the curvature being smaller than a first reference value, the length of the curvature section being greater than a second reference value, and presence of alteration in the sign of the curvature.

According to an embodiment of the disclosure, the road curvature information may include a radius of curvature including a sign of the curvature, a length of a curvature section, and a first distance corresponding to a distance between a curvature section starting point and the vehicle. The processor may further identify whether the sign of the curvature is altered, based on the radius of the curvature being smaller than a first reference value, the length of the curvature section being greater than a second reference value, and the first distance being greater than or equal to a third reference value, and identifies that the deceleration event will occur based on the road curvature information upon the presence of the alteration in the sign of the curvature.

According to an embodiment of the disclosure, the road curvature information may include a radius of curvature including a sign of the curvature. The processor may determine an absolute value for the radius of the curvature, search information about speeds corresponding to the radius of the curvature for a speed corresponding to the absolute value, and determine the searched speed as the target vehicle speed.

According to an embodiment of the disclosure, the processor may further determine a remaining distance from a current location of the vehicle to a starting point of the deceleration event.

According to an embodiment of the disclosure, the road curvature information may include a first distance corresponding to a distance between a curvature section starting point and the vehicle, the necessary operation information may include a vehicle speed for the vehicle, and the processor may determine the remaining distance by subtracting a vehicle speed integral value from the first distance.

According to an embodiment of the disclosure, the necessary operation information may include current location information of the vehicle, and the processor may determine the remaining distance based on the current location information of the vehicle.

According to an embodiment of the disclosure, based on the presence of multiple deceleration events, the processor may determine the remaining distance for each of the multiple deceleration events, and determine, among the multiple deceleration events, deceleration events as a single deceleration event when differences in the remaining distances between the multiple deceleration events are smaller than or equal to a preset threshold.

According to an embodiment of the disclosure, the processor may determine a minimum value of the target vehicle speeds determined for the deceleration events, which are identified to be the same, as the target vehicle speed for the single deceleration event.

According to an embodiment of the disclosure, the processor may determine the inertia driving control time for the deceleration event based on the target vehicle speed and the remaining distance.

According to an embodiment of the disclosure, the processor may determine the inertia driving control time based on a distance required to reach the target vehicle speed by the inertia driving being greater than or equal to a first set distance value, and the remaining distance being greater than or equal to a second set distance value.

According to an embodiment of the disclosure, upon more than a preset number of pieces of road curvature information being received within a present distance, the processor may determine a priority of the deceleration event based on the road curvature information, and selectively perform the inertia driving control for the piece of road curvature information having a highest priority.

according to an embodiment of the disclosure, a method of controlling inertia driving may include: determining whether a deceleration event will occur based on road curvature information contained in received necessary operation information; determining a target vehicle speed, an inertia driving control time, and control torque for inertia driving control based on the road curvature information indicative of the presence of the deceleration event; and controlling an actuator to perform the inertia driving control for the deceleration event based on determination results.

According to an embodiment of the disclosure, a vehicle may include: an information providing apparatus configured to provide necessary operation information required for inertia driving control of the vehicle; and an inertia driving control apparatus configured to determine whether a deceleration event is present based on road curvature information contained in the necessary operation information, determine target vehicle speed, inertia driving control time, and control torque for the inertia driving control based on the road curvature information indicative of the presence of the deceleration event, and control an actuator to perform the inertia driving control for the deceleration event based on determination results.

According to an embodiment of the disclosure, the road curvature information may comprise a radius of curvature comprising a sign of the curvature, a length of a curvature section, and a first distance corresponding to a distance between a curvature section starting point and the vehicle.

According to an embodiment of the disclosure, the inertia driving control apparatus may be configured to determine that the deceleration event will occur based on the road curvature information, wherein the determination is made based on the radius of the curvature being smaller than a first reference value, the length of the curvature section being greater than a second reference value, and the first distance being smaller than a third reference value.

According to an embodiment of the disclosure, the inertia driving control apparatus may be configured to determine that the deceleration event will occur based on the road curvature information, wherein the determination is made based on the radius of the curvature being smaller than a first reference value, the length of the curvature section being greater than a second reference value, and presence of alteration in the sign of the curvature.

According to an embodiment of the disclosure, the inertia driving control apparatus may be configured to: determine whether the sign of the curvature is altered based on the radius of the curvature being smaller than a first reference value, the length of the curvature section being greater than a second reference value, and the first distance being greater than or equal to a third reference value; and determine that the deceleration event will occur in the road curvature information upon the presence of the alteration in the sign of the curvature.

According to an embodiment of the disclosure, the road curvature information may comprise a radius of curvature comprising a sign of the curvature. The inertia driving control apparatus may be configured to determine an absolute value for the radius of the curvature, search information about speeds corresponding to the radius of the curvature for a speed corresponding to the absolute value, and determine the searched speed as the target vehicle speed.

According to an embodiment of the disclosure, there are provided an apparatus implemented to perform inertia driving control based on curvature information of a road on which an eco-friendly vehicle travels (i.e., based on road curvature information), an inertia driving control method thereof, and an eco-friendly vehicle including the same.

According to an embodiment of the disclosure, an apparatus and method for controlling inertia driving control are implemented to perform the inertia driving control based on road curvature information, and thus perform the inertia driving control even in situations other than road junctions. Therefore, the range of the inertia driving control is expanded, thereby further improving the energy efficiency of an eco-friendly vehicle.

It should be noted that effects of the disclosure are not limited to those described above and other effects not mentioned above should be apparent to those of ordinary skill in the art from the following description.

### BRIEF DESCRIPTION OF THE DRAWINGS

The accompanying drawings are intended to enhance understanding of embodiments of the disclosure, and provide detailed descriptions and embodiments. However, the technical features of the embodiments are not limited to the specific drawings, and the features disclosed in the drawings may be combined to form a new embodiment.

FIG. 1 is a diagram showing a vehicle 1 including an inertia driving control apparatus for controlling inertia driving according to an embodiment of the disclosure.

FIG. 2 is a diagram showing a configuration of the inertia driving control apparatus for controlling the inertia driving according to an embodiment of the disclosure.

FIG. 3 is a diagram for describing a method of controlling inertia driving, implemented by the inertia driving control apparatus for controlling the inertia driving according to an embodiment of the disclosure.

FIG. 4 is a diagram for specifically describing step S310 of identifying the presence of a deceleration event in FIG. 3.

### DETAILED DESCRIPTION

In terms of describing several embodiments of the disclosure, detailed descriptions of related art have been omitted where they may make the subject matter of the embodiments of the disclosure unclear. In addition, the accompanying drawings are provided only to enhance or improve understanding of the embodiments of the disclosure and are not intended to limit technical ideas of the disclosure. Therefore, it should be understood that the accompanying drawings include all modifications, equivalents and substitutions within the scope and spirit of the disclosure.

Terms such as “first” and “second” may be used to describe various components, but the components should not be limited by the above terms. In addition, the above terms are used only for the purpose of distinguishing one component from another.

Unless the context clearly dictates otherwise, singular forms include plural forms as well.

In the disclosure, it should be understood that term “include” or “have” indicates that a feature, a number, a step, an operation, an element, a part, or the combination thereof described in the embodiments is present, but does not preclude a possibility of presence or addition of one or more other features, numbers, steps, operations, elements, parts or combinations thereof, in advance.

Suffixes “module” and “unit” put after the terms for components in the following description are given in consideration of only ease of description and do not have meaning or functions discriminated from each other.

When it is described that one component is “connected” or “joined” to another component, it should be understood that the one component may be directly connected or joined to another component, but additional components may be present therebetween. However, when one component is described as being “directly connected,” or “directly coupled” to another component, it should be understood that additional components may be absent between the one component and another component. When a component, device, element, or the like of the present disclosure is described as having a purpose or performing an operation, function, or the like, the component, device, or element should be considered herein as being “configured to” meet that purpose or perform that operation or function.

Below, embodiments of the disclosure are described in detail with reference to the accompanying drawings, in which the same or similar elements are denoted by the same reference numerals even though they are depicted in different drawings and redundant descriptions thereof have been omitted.

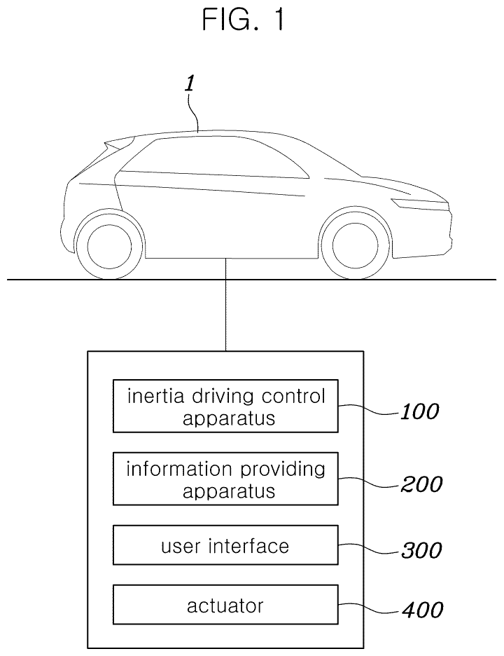

FIG. 1 is a diagram showing a vehicle 1 including an inertia driving control apparatus 100 for controlling inertia driving according to an embodiment of the disclosure.

Referring to FIG. 1, the vehicle 1 according to an embodiment of the disclosure may include the inertia driving control apparatus 100 for controlling the inertia driving (or an inertia driving control apparatus or controller).

For example, the inertia driving control apparatus 100 for controlling the inertia driving may be referred to as an inertia driving control apparatus (or controller), an inertia driving guide device, an inertia driving guide, etc.

Further, the vehicle 1 may include an information providing apparatus 200 that provides information needed for operating the inertia driving control apparatus 100 (hereinafter referred to as ‘necessary operation information’), a user interface 300 that outputs information under the control of the inertia driving control apparatus 100, and an actuator 400 that operates under the control of the inertia driving control apparatus 100.

The vehicle 1 may refer to an eco-friendly vehicle provided with a motor as a power source. For example, the vehicle 1 may include an electric vehicle (EV), a hybrid electric vehicle (HEV), a plugin hybrid electric vehicle (PHEV), a fuel cell electric vehicle (FCEV), etc.

According to an embodiment, the inertia driving control apparatus 100 is operated by an inertia driving control algorithm based on the necessary operation information provided from the information providing apparatus 200 and functions to control the inertia driving of the vehicle 1.

For example, the inertia driving control apparatus 100 may receive road curvature information of a route on which vehicle 1 travels, current location information of the vehicle 1, vehicle speed information, etc. from the information providing apparatus 200.

According to an embodiment, when it is identified based on the necessary operation information that a deceleration event (or deceleration situation) occurs, the inertia driving control apparatus 100 may display inertia driving guidance through the user interface 300, and control the actuator 400 to perform the inertia driving control.

The configurations and operations of the inertia driving control apparatus 100 are described hereinafter in detail.

The information providing apparatus 200 may obtain information needed for operating the inertia driving control apparatus 100 (i.e., the necessary operation information), and provide the necessary operation information to the inertia driving control apparatus 100.

According to an embodiment, the information providing apparatus 200 may refer to a global positioning system (GPS), which may provide the road curvature information of a travel route, the current location information of the vehicle 1, the vehicle speed information, etc. to the inertia driving control apparatus 100.

For example, the road curvature information may include a radius/sign of curvature of a curvature section, the length of the curvature section, a distance between a curvature section starting point and the vehicle 1 at a point in time of generating (or providing) the road curvature information, and the like.

For example, the information providing apparatus 200 may provide information about all the curvature sections within a preset distance from the vehicle 1 to the inertia driving control apparatus 100.

For example, when the preset distance is 2 km and four curvature sections are present within 2 km ahead on the travel route of the vehicle 1, the information providing apparatus 200 provides curvature information about the four curvature sections to the inertia driving control apparatus 100.

Of course, the information providing apparatus 200 is not limited to the GPS, and may include any apparatus as long as it can provide the road curvature information of the travel route, the current location information and speed information of the vehicle 1, and the like.

The user interface 300 may display inertia driving guidance under the control of the inertia driving control apparatus 100.

For example, the user interface 300 may be implemented as one of audio video navigation (AVN), a cluster, and a heads-up display, and the type of the user interface 300 is not limited to these examples.

The actuator 400 operates under the control of the inertia driving control apparatus 100, thereby actuating the vehicle 1 based on the inertia driving.

For example, the actuator 400 may include the motor, transmission, etc., and the type of the actuator 400 is not limited to this example.

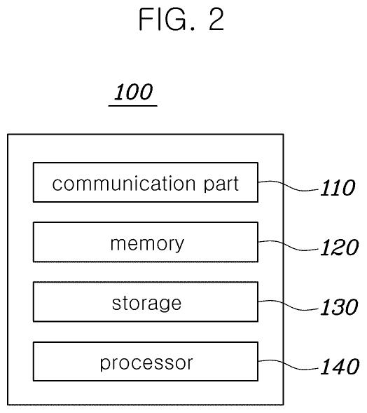

FIG. 2 is a diagram showing the configuration of the inertia driving control apparatus 100 according to an embodiment of the disclosure.

The inertia driving control apparatus 100 may identify whether the deceleration event (or deceleration situation) occurs or will occur based on the received necessary operation information, and controls the user interface 300 to display the inertia driving guidance and the actuator 400 to perform the inertia driving control when it is identified that the deceleration event will occur.

For example, the inertia driving control apparatus 100 may be implemented including a hybrid control unit (HCU), a vehicle control unit (VCU), a motor control unit (MCU), and an electronic control unit (ECU), etc., and may include any control unit capable of performing the inertia driving guidance and control.

Referring to FIG. 2, the inertia driving control apparatus 100 may include, but not limited to, a communication part or communication interface 110, a memory 120, a storage 130, and a processor 140.

The communication part or communication interface 110 may be provided for communication between the inertia driving control apparatus 100 and other devices of the vehicle 1. For example, the communication part or the communication interface 110 may be an electronic control unit (ECU) for controlling one or more operations related to driving of the vehicle and receiving information from one or more component of the vehicle (e.g., an engine, transmission, and the like).

For example, the communication part or the communication interface 110 may communicate with the information providing apparatus 200, the user interface 300, and the actuator 400, and transmit and receive information, data, or control signals (or instructions) through communication.

The communication part or the communication interface 110 may include one or multiple communication modules (or communication circuits). One or multiple communication modules may communicate with the information providing apparatus 200, the user interface 300, and the actuator 400 based on a preset vehicle communication protocol.

For example, the vehicle communication protocol may include, but not limited to, a local interconnect network (LIN), a controller area network (CAN), FlexRay, Ethernet, etc.

The memory 120 may be configured to store an algorithm (or program or software), data, etc. to perform the operations of the inertia driving control apparatus 100.

The storage 130 may be configured to store information and the like acquired or generated during the operation of the inertia driving control apparatus 100.

For example, the memory 120 and the storage 130 may be implemented by at least one storage medium (or recording medium) such as a flash memory, a hard disk, a secure digital (SD) card, a random access memory (RAM), a static random access memory (SRAM), a read only memory (ROM), a programmable read only memory (PROM), an electrically erasable and programmable ROM (EEPROM), an erasable and programmable ROM (EPROM), a register, a removable disk, and a web storage.

The processor 140 may perform the inertia driving control based on the algorithm/data stored in the memory 120, the necessary operation information provided by the information providing apparatus 200, etc.

The processor 140 may refer to a data processing device implemented as hardware having a circuit with a physical structure to execute desired operations. For example, the desired operations may include codes or instructions included in the program.

For example, the data processing device implemented as the hardware may include a microprocessor, a central processing unit, a processor core, a multi-core processor, and a multiprocessor, an application-specific integrated circuit (ASIC), and a field programmable gate array (FPGA).

According to an embodiment, the processor 140 may identify the presence of the deceleration event based on the necessary operation information provided by the information providing apparatus 200.

Here, the necessary operation information may include the road curvature information of the route on which the vehicle 1 travels, the current location information and speed information of the vehicle 1, etc.

For example, the road curvature information may include a radius of curvature of a curvature section, the length of the curvature section, and a distance between a curvature section starting point and the vehicle 1, and the like, and the radius of the curvature may have a sign (+, −) of the curvature to indicate a direction of a curve.

The processor 140 may identify the presence of the deceleration event in relation to the road curvature information, based on the radius of the curvature, the length of the curvature section, the distance between the curvature section starting point and the vehicle 1, the presence of alteration in the sign of the curvature within the curvature section, etc.

For example, when the radius of the curvature is smaller than a first reference value, the length of the curvature section is greater than a second reference value, and the distance between the curvature section starting point and the vehicle 1 is smaller than a third reference value, the processor 140 may identify that the deceleration event based on the corresponding road curvature information is present (e.g., will occur).

Here, the first reference value, the second reference value, and the third reference value may be stored in the memory 120, and may be set based on various tests (or experiments) under a real road environment and/or a virtual environment.

For example, when the radius of the curvature is smaller than the first reference value, the length of the curvature section is greater than the second reference value, and the sign of the curvature is altered within the curvature section, the processor 140 may identify that the deceleration event based on the corresponding road curvature information is present.

According to an embodiment, the processor 140 may identify the presence of the deceleration event with respect to the multiple pieces of road curvature information.

According to an embodiment, the processor 140 may store the road curvature information, from which the presence of the deceleration event is identified, in a storage device (e.g., the memory 120 or the storage 130).

Details of identifying the presence of the deceleration event are described hereinafter.

According to an embodiment, when it is identified that the deceleration event is present, the processor 140 may determine or identify (or set) a target vehicle speed for the corresponding deceleration event based on the radius of the curvature information.

For example, the processor 140 may calculate an absolute value for the radius of the curvature, search a previously stored table, in which speeds are tabulated corresponding the radii of curvature, for the speed corresponding to the absolute value, and set (e.g., determine, identify) the searched speed as the target vehicle speed for the corresponding curvature section.

For example, the table, in which speeds are tabulated corresponding the radii of curvature, may be stored in the memory 120, and may be generated based on various tests (or experiments) under a real road environment and/or a virtual environment.

The processor 140 may store the deceleration event information and the target vehicle speed in at least one of the memory 120 or the storage 130 by mapping them.

According to an embodiment, the processor 140 may determine or identify a remaining distance from the current location of the vehicle 1 to a deceleration event starting point.

For example, the processor 140 may identify the remaining distance to the deceleration event starting point by subtracting a vehicle speed integral value from a vehicle location, based on vehicle location information and vehicle speed information included in the necessary operation information.

For example, the processor 140 may identify the remaining distance to the deceleration event starting point based on the vehicle location information provided from the information providing apparatus 200.

Here, the vehicle location information may be provided separately from the road curvature information.

According to an embodiment, when the vehicle 1 passes a deceleration event point, when the navigation searches for the travel route again, or when the sign of the curvature included in the road curvature information is altered, the processor 140 may reset the remaining distance related to the corresponding deceleration event.

According to an embodiment, multiple pieces of road curvature information may be provided from the information providing apparatus 200 to the inertia driving control apparatus 100 in one operation cycle.

Accordingly, the processor 140 may identify the deceleration events, between which differences in the remaining distance identified corresponding to the pieces of information are smaller than or equal to a preset threshold, as one deceleration event.

For example, the threshold used in determining or identifying whether the deceleration events are the same may be stored in the memory 120, and may be set based on various tests (or experiments) under the real road environment and/or the virtual environment.

The processor 140 may set the minimum value of the target vehicle speeds set for the deceleration events, which are identified to be the same, as the target vehicle speed for the corresponding deceleration event.

According to an embodiment, the processor 140 may determine or identify the inertia driving control time based on the target vehicle speed and the remaining distance for the deceleration event.

When the distance required to reach the target vehicle speed with the inertia driving, and the remaining distance from the current location of the vehicle 1 to the deceleration event starting point are short, it may not be suitable for performing the inertia driving control.

For example, when the distance required to reach the target vehicle speed by the inertia driving is greater than or equal to a set distance value (or first set distance value), and the remaining distance from the current location of the vehicle 1 to the deceleration event starting point is greater than or equal to a set distance value (or second set distance value), the processor 140 may determine or identify the inertia driving control time.

For example, the first set distance value and the second set distance value may be set differently based on the target vehicle speed, and may be set based on various tests (or experiments) under the real road environment and/or the virtual environment.

According to an embodiment, the processor 140 may determine or identify feedback control torque and feedforward control torque, and perform the inertia driving control based on the identified control torque.

For example, the processor 140 may identify the feedback control torque by multiplying a proportional-integral (PI) gain and a difference between the current vehicle speed and the target vehicle speed, while performing proportional-integral-differential (PID) control from the current location of the vehicle 1 to the deceleration event starting point.

For example, the processor 140 may determine or identify the feedforward control torque based on the vehicle speed expected when reaching the deceleration event starting point by coasting driving.

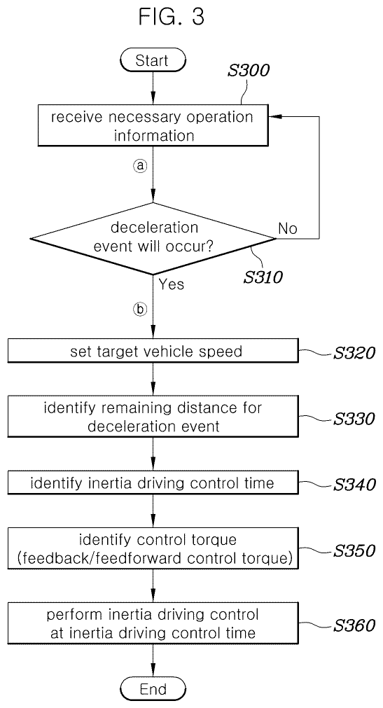

FIG. 3 is a diagram for describing a method of controlling inertia driving, implemented by the inertia driving control apparatus 100 according to an embodiment of the disclosure.

The operations shown in FIG. 3 may be performed by the inertia driving control apparatus 100 described with reference to FIGS. 1 and 2.

The inertia driving control method according to an embodiment of the disclosure is described with reference to FIGS. 1-3, assuming that the inertia driving control apparatus 100 receives the necessary operation information provided by the information providing apparatus 200.

When receiving the necessary operation information (S300), the inertia driving control apparatus 100 may identify whether the deceleration event is present on the travel route of the vehicle 1 based on the necessary operation information (S310).

According to an embodiment, the necessary operation information may include road curvature information related to all the curvature sections within the preset distance from the vehicle 1, and the current location and speed of the vehicle 1, etc.

Here, the road curvature information may include a radius/sign of curvature of a curvature section, the length of the curvature section, a distance between a curvature section starting point (or event starting point) and the vehicle 1, etc.

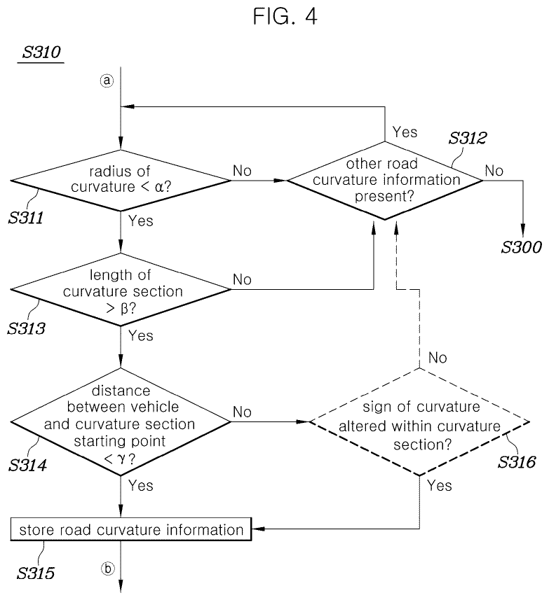

Detailed operations in step S310 are described hereinafter with reference to FIG. 4.

When it is identified that the deceleration event is absent or will not occur (S310—No), the inertia driving control apparatus 100 may receive the necessary operation information (S300). In other words, the inertia driving control apparatus 100 may continuously receive the necessary operation information while being turned on.

When it is identified that the deceleration event is present (e.g., that a deceleration event will occur) (S310—Yes), the inertia driving control apparatus 100 may set the target vehicle speed for the deceleration event based on information about the radius of the curvature in the road curvature information (S320).

In step S320, the inertia driving control apparatus 100 may calculate the absolute value for the radius of the curvature, search the information about the speeds corresponding to the radii of curvature for the speed corresponding to the absolute value, and set the searched speed as the target vehicle speed for the corresponding deceleration event.

According to an embodiment, when it is identified in S310 that multiple deceleration events are present, the inertia driving control apparatus 100 may set the target vehicle speed for each of the multiple deceleration events.

Then, the inertia driving control apparatus 100 may identify the remaining distance from the current location of vehicle 1 to the deceleration event starting point (S330).

In step S330, the inertia driving control apparatus 100 may identify the remaining distance to the deceleration event starting point by subtracting the vehicle speed integral value from the vehicle location, based on the vehicle location information and the vehicle speed information included in the necessary operation information.

In step S330, the inertia driving control apparatus 100 may identify the remaining distance to the deceleration event starting point based on the current location information of the vehicle 1 provided from the information providing apparatus 200.

According to an embodiment, when it is identified in step S330 that multiple deceleration events are present, the inertia driving control apparatus 100 may identify the remaining distance for each of the multiple deceleration events.

In addition, the inertia driving control apparatus 100 may compare the remaining distances respectively identified for the multiple deceleration events, and identify the deceleration events, between which differences in the remaining distance are smaller than or equal to the preset threshold, as one deceleration event.

The inertia driving control apparatus 100 may compare the target vehicle speeds set for the deceleration events identified to be the same, and set the minimum value among the target vehicle speeds as the target vehicle speed for that deceleration event.

After step S330, the inertia driving control apparatus 100 may determine or identify the inertia driving control time based on the target vehicle speed and remaining distance for the deceleration event (S340).

For example, the inertia driving control apparatus 100 may identify the inertia driving control time when the distance required to reach the target vehicle speed by the inertia driving is greater than or equal to a set distance value (or first set distance value), and the remaining distance from the current location of the vehicle 1 to the deceleration event starting point is greater than or equal to a set distance value (or second set distance value).

After step S340, the inertia driving control apparatus 100 may identify the control torque (feedback torque and feedforward torque) for controlling the inertia driving (S350).

After step S350, the inertia driving control apparatus 100 may perform the inertia driving control based on the control torque when reaching the inertia driving control time (S360).

FIG. 4 is a diagram for specifically describing step S310 of identifying the presence of a deceleration event in FIG. 3.

Referring to FIG. 4, the inertia driving control apparatus 100 may identify whether the deceleration event is present on the travel route of the vehicle 1 based on the necessary operation information provided from the information providing apparatus 200.

Specifically, the inertia driving control apparatus 100 may compare the radius of the curvature included in the road curvature information with a reference value α, and identify that the radius of the curvature is smaller than the reference value α (first reference value) (S311).

When the radius of the curvature is greater than or equal to the first reference value (α) (S311—No), the inertia driving control apparatus 100 may identify whether other pieces of road curvature information are present in the necessary operation information (S312). When the other pieces of road curvature information are absent (S312—No), the inertia driving control apparatus 100 may receive the necessary operation information for the next operation cycle (S300).

When the other pieces of road curvature information are present (S312—Yes), the inertia driving control apparatus 100 may perform step S311 for the information about the radius of the curvature included in the other pieces of road curvature information.

Meanwhile, when it is identified in step S311 that the radius of the curvature is smaller than the first reference value α (S311—Yes), the inertia driving control apparatus 100 may identify whether the length of the curvature section included in the road curvature information is greater than a reference value β (second reference value) (S313).

When the length of the curvature section is smaller than or equal to the second reference value β (S313—No), the inertia driving control apparatus 100 may enter step S312 to identify whether other pieces of road curvature information are present.

When the length of the curvature section is greater than the second reference value β (S313—Yes), the inertia driving control apparatus 100 may identify whether a distance between the vehicle 1 and the curvature section starting point included in the road curvature information is smaller than a reference value γ (third reference value) (S314).

When the distance between the curvature section starting point and the vehicle 1 is greater than or equal to the third reference value γ (S314—No), the inertia driving control apparatus 100 may enter step S312 to identify whether other pieces of road curvature information are present.

When the distance between the curvature section starting point and the vehicle 1 is smaller than the third reference value γ (S314—Yes), the inertia driving control apparatus 100 may identify that the deceleration event based on the corresponding road curvature information is present (S310—Yes).

In addition, the inertia driving control apparatus 100 may store the road curvature information related to the deceleration event (S315).

According to an embodiment, when the distance between the curvature section starting point and the vehicle 1 is greater than or equal to the third reference value γ (S314—No), the inertia driving control apparatus 100 may identify whether the sign of the curvature is altered within the curvature section, based on information about the sign of curvature of the curvature section included in the road curvature information (S316).

When the sign of the curvature is not altered within the curvature section (S316—No), the inertia driving control apparatus 100 may enter step S312 to identify whether other pieces of road curvature information are present.

When the sign of the curvature is altered within the curvature section (S316—Yes), the inertia driving control apparatus 100 may identify that the deceleration event based on the corresponding road curvature information is present (S310—Yes).

In addition, the inertia driving control apparatus 100 may store the road curvature information related to the deceleration event (S315).

According to an embodiment, when more than a preset number of pieces of road curvature information are received within a preset distance, the inertia driving control apparatus 100 may identify the priority of the deceleration event based on comparison between the pieces of road curvature information, and selectively perform the inertia driving control for the piece of road curvature information having the highest priority.

For example, the priority may be identified based on the size of the radius of curvature, the presence of alteration in the sign of the curvature, the number of alterations in the sign of the curvature, the length of the curvature section, etc.

Although a few embodiments of the disclosure have been described in more detail with reference to the accompanying drawings, the disclosure is not necessarily limited to these embodiments, and may be variously modified without departing from the scope of the disclosure. Accordingly, the embodiments disclosed herein are intended not to restrict but to illustrate the technical idea of the disclosure, and the scope of the disclosure is not limited by these embodiments. Therefore, it should be understood that the embodiments described above are not restrictive but illustrative in all respects. The scope of the disclosure should be interpreted by the appended claims, and all technical ideas within the equivalent scope should be interpreted as falling into the scope of the disclosure.

What is claimed is:

1. An apparatus for controlling inertia driving, the apparatus comprising:
a communication interface configured to receive necessary operation information required for inertia driving control of a vehicle; and
a processor configured to:
determine whether a deceleration event will occur based on road curvature information contained in the necessary operation information,
determine a target vehicle speed,
determine inertia driving control time,
control torque for the inertia driving control based on the road curvature information indicative of the deceleration event, and
control an actuator to perform the inertia driving control for the deceleration event based on determination results.

2. The apparatus of claim 1, wherein
the road curvature information comprises a radius of curvature comprising a sign of the curvature, a length of a curvature section, and a first distance corresponding to a distance between a curvature section starting point and the vehicle, and
the processor is configured to determine that the deceleration event will occur based on the road curvature information, wherein the determination is made based on the radius of the curvature being smaller than a first reference value, the length of the curvature section being greater than a second reference value, and the first distance being smaller than a third reference value.

3. The apparatus of claim 1, wherein
the road curvature information comprises a radius of curvature comprising a sign of the curvature, a length of a curvature section, and a first distance corresponding to a distance between a curvature section starting point and the vehicle, and
the processor is configured to determine that the deceleration event will occur based on the road curvature information, wherein the determination is made based on the radius of the curvature being smaller than a first reference value, the length of the curvature section being greater than a second reference value, and presence of alteration in the sign of the curvature.

4. The apparatus of claim 1, wherein
the road curvature information comprises a radius of curvature comprising a sign of the curvature, a length of a curvature section, and a first distance corresponding to a distance between a curvature section starting point and the vehicle, and
the processor is configured to:
determine whether the sign of the curvature is altered based on the radius of the curvature being smaller than a first reference value, the length of the curvature section being greater than a second reference value, and the first distance being greater than or equal to a third reference value, and
determine that the deceleration event will occur in the road curvature information upon presence of the alteration in the sign of the curvature.

5. The apparatus of claim 1, wherein
the road curvature information comprises a radius of curvature comprising a sign of the curvature, and
the processor is configured to:
determine an absolute value for the radius of the curvature,
search information about speeds corresponding to the radius of the curvature for a speed corresponding to the absolute value, and
determine the searched speed as the target vehicle speed.

6. The apparatus of claim 1, wherein the processor is configured to determine a remaining distance from a current location of the vehicle to a starting point of the deceleration event.

7. The apparatus of claim 6, wherein:
the road curvature: information comprises a first distance corresponding to a distance between a curvature section starting point and the vehicle,
the necessary operation information comprises a vehicle speed for the vehicle, and
the processor is configured to determine the remaining distance by subtracting a vehicle speed integral value from the first distance.

8. The apparatus of claim 6, wherein
the necessary operation information comprises current location information of the vehicle, and
the processor is configured to determine the remaining distance based on the current location information of the vehicle.

9. The apparatus of claim 6, wherein, based on presence of multiple deceleration events, the processor is configured to:
determine the remaining distance for each of the multiple deceleration events, and
determine, among the multiple deceleration events, deceleration events as a single deceleration event when differences in the remaining distances between the multiple deceleration events are smaller than or equal to a preset threshold.

10. The apparatus of claim 9, wherein the processor is configured to determine a minimum value of the target vehicle speeds determined for the deceleration events, which are identified to be the same, as the target vehicle speed for the single deceleration event.

11. The apparatus of claim 6, wherein the processor is configured to determine the inertia driving control time for the deceleration event based on the target vehicle speed and the remaining distance.

12. The apparatus of claim 11, wherein the processor is configured to determine the inertia driving control time based on a distance required to reach the target vehicle speed by the inertia driving being greater than or equal to a first set distance value, and the remaining distance being greater than or equal to a second set distance value.

13. The apparatus of claim 1, wherein the processor is configured to:
upon more than a preset number of pieces of road curvature information being received within a preset distance, determine a priority of the deceleration event based on the road curvature information, and
selectively perform the inertia driving control for the piece of road curvature information having the highest priority,
wherein the priority is determined based on at least one of a size of a radius of curvature, presence of alteration in a sign of the curvature, a number of alterations in the sign of the curvature, or a length of a curvature section of the respective pieces of road curvature information.

14. A method of controlling inertia driving, the method comprising:
determining whether a deceleration event will occur based on road information contained in received necessary operation curvature information;
determining a target vehicle speed, an inertia driving control time, and a control torque for inertia driving control based on the road curvature information indicative of presence of the deceleration event; and
controlling an actuator to perform the inertia driving control for the deceleration event based on determination results.

15. An eco-friendly vehicle comprising:
an information providing apparatus configured to provide necessary operation information required for inertia driving control of the vehicle; and
an inertia driving control apparatus configured to determine whether a deceleration event is present based on road curvature information contained in the necessary operation information, determine target vehicle speed, inertia driving control time, and control torque for the inertia driving control based on the road curvature information indicative of presence of the deceleration event, and control an actuator to perform the inertia driving control for the deceleration event based on determination results.

16. The eco-friendly vehicle of claim 15, wherein
the road curvature information comprises a radius of curvature comprising a sign of the curvature, a length of a curvature section, and a first distance corresponding to a distance between a curvature section starting point and the vehicle.

17. The eco-friendly vehicle of claim 16, wherein the inertia driving control apparatus is configured to:
determine that the deceleration event will occur based on the road curvature information, wherein the determination is made based on the radius of the curvature being smaller than a first reference value, the length of the curvature section being greater than a second reference value, and the first distance being smaller than a third reference value.

18. The eco-friendly vehicle of claim 16, wherein the inertia driving control apparatus is configured to:
determine that the deceleration event will occur based on the road curvature information, wherein the determination is made based on the radius of the curvature being smaller than a first reference value, the length of the curvature section being greater than a second reference value, and presence of alteration in the sign of the curvature.

19. The eco-friendly vehicle of claim 16, wherein the inertia driving control apparatus is configured to:
determine whether the sign of the curvature is altered based on the radius of the curvature being smaller than a first reference value, the length of the curvature section being greater than a second reference value, and the first distance being greater than or equal to a third reference value, and
determine that the deceleration event will occur in the road curvature information upon presence of the alteration in the sign of the curvature.

20. The eco-friendly vehicle of claim 15, wherein:
the road curvature information comprises a radius of curvature comprising a sign of the curvature, and
the inertia driving control apparatus is configured to:
determine an absolute value for the radius of the curvature,
search information about speeds corresponding to the radius of the curvature for a speed corresponding to the absolute value, and
determine the searched speed as the target vehicle speed.
